(19) United States
(12) Patent Application Publication
(10) Pub. No.: US 2020/0323204 A1
(43) Pub. Date: Oct. 15, 2020

(54) Tank-Mix

(71) Applicant: BASF SE, Ludwigshafen am Rhein (DE)

(72) Inventors: Kristin Tiefensee, Ludwigshafen (DE); Markus Kalt, Ludwigshafen (DE)

(21) Appl. No.: 16/760,255

(22) PCT Filed: Nov. 12, 2018
(86) PCT No.: PCT/EP2018/080863

§ 371 Date: Apr. 29, 2020

(30) Foreign Application Priority Data
Nov. 15, 2017 (EP) 17201773.3

(51) Int. Cl. A01N 37/34; A01N 37/16; A01N 25/02

(52) U.S. Cl. CPC A01N 37/34; A01N 25/02; A01N 37/16

(57) ABSTRACT

A tank-mix is disclosed herein including a) 1,2-cyclohexandicarboxylic acid diisononyl ester, b) a mixture of anionic surfactants selected from b1) alkylbenzenesulfonates and b2) sulfosuccinate, and c) a nonionic surfactant. A weight % ratio of b1):b2) is 3:1 to 20:1 and a weight % ratio of anionic surfactants to nonionic surfactant is b1)+b2)≥c).

A spray mix is further disclosed including said tank mix and a pesticide. A process is also disclosed for the preparation of said spray mix; and to a method for controlling phytopathogenic fungi and/or undesirable plant growth and/or undesirable insect or mite infestation and/or for regulating the growth of plants. The method includes allowing the spray mix to act on the respective pests, the habit thereof or the plants to be protected from the respective pest, on the soil and/or on undesirable plants and/or the crop plants and/or the habitat thereof.

The present invention relates to a tank-mix consisting of a) 1,2-cyclohexandicarboxylic acid diisononyl ester, b) a mixture of anionic surfactants selected from b1) alkylbenzenesulfonates and b2) sulfosuccinate, and c) a nonionic surfactant, wherein the weight % ratio of b1):b2) is 3:1 to 20:1 and wherein the weight % ratio of anionic surfactants to nonionic surfactant is b1)+b2)≥c. The invention further relates to a spray mix comprising said tank mix and a pesticide. The invention further relates to a process for the preparation of said spray mix; and to a method for controlling phytopathogenic fungi and/or undesirable plant growth and/or undesirable insect or mite infestation and/or for regulating the growth of plants, wherein the spray mix is allowed to act on the respective pests, the habit thereof or the plants to be protected from the respective pest, on the soil and/or on undesirable plants and/or the crop plants and/or the habitat thereof. The present invention comprises combinations of preferred features with other preferred features.

Agricultural spray adjuvants are used to enhance the effectiveness of pesticides such as herbicides, insecticides, fungicides and other agents that control or eliminate unwanted pests. These agricultural spray adjuvants enhance the ability of the pesticide to penetrate, target or protect the target organism. They contain a variety of ingredients, in particular surfactants, emulsifiers, oils and salts. Each of these ingredients, and others, modifies the spray solution itself to also improve such properties as spreading, penetration, droplet size or other characteristics. These additives may be included in a formulation with a pesticide or may be added separately to a tank. Agricultural spray adjuvants may also be added separately when the spray solution is being prepared. In this case, the adjuvant is called a tank mix adjuvant. Because of limited space or limited compatibility in a pesticide formulation, not all necessary adjuvants may be included in-can. Thus, the addition of tank mix adjuvants may be necessary to optimize performance of the pesticide. Tank-mixes are widely used formulations in crop protection.

WO 2011/109689 describes an emulsifiable concentrate comprising a solvent component comprising 1,2-cyclohexandicarboxylic acid diisononyl ester, an active component, and an emulsifier component comprising an anionic surfactant, a nonionic surfactant and a surfactant different from said anionic surfactant and said nonionic surfactant and comprising at least one ethylene oxide block. WO 2001/067860 describes an agrotechnical formulation containing in relation to the total weight of the formulation: a) between 20 and 99.9 wt.-% of at least one cyclohexane polycarboxlic acid ester; b) between 0 and 70 wt.-% of water; c) between 0.1 and 60 wt.-% of at least one auxiliary agent and/or additive; and d) between 0 and 70 wt.-% of at least one active ingredient for treating plants.

However, there is still a need in the agrochemical industry to provide further stable tank-mixes.

Therefore, it was an object of the present invention to provide tank-mixes which are stable for more than 24 hours.

The object was achieved by a tank-mix consisting of
a) 1,2-cyclohexandicarboxylic acid diisononyl ester,
b) a mixture of anionic surfactants selected from b1) alkylbenzenesulfonates and b2) sulfosuccinates, and
c) a nonionic surfactant,

wherein the weight % ratio of b1) to b2) is 3:1 to 20:1 and wherein the weight % ratio of anionic surfactants to nonionic surfactant is b1)+b2)≥c).

Alkyl in the context of the present invention shall mean branched or linear alkyl chains as well as saturated or unsaturated alkyl chains.

In another embodiment, the tank-mix consists of
a) 1,2-cyclohexandicarboxylic acid diisononyl ester,
b) a mixture of anionic surfactants selected from b1) alkylbenzenesulfonates and b2) sulfosuccinates, and
c) a nonionic surfactant,

wherein the weight % ratio of b1) to b2) is 3:1 to 20:1, wherein the weight % ratio of anionic surfactants to nonionic surfactant is b1)+b2)≥c) and wherein the weight % ratio of 1,2-cyclohexandicarboxylic acid diisononyl ester to anionic surfactants and nonionic surfactant is a)≥[b1)+b2)+c)].

In another embodiment, the tank-mix consists of
a) 70 to 92 weight % of 1,2-cyclohexandicarboxylic acid diisononyl ester,
b) 4 to 15 weight % of a mixture of anionic surfactants selected from b1) alkylbenzenesulfonates and b2) sulfosuccinates, wherein b1) is present in an amount of 75 to 95 weight % and b2) is present in an amount of 5 to 25 weight % based on the total weight of anionic surfactants, and
c) 4 to 15 weight % of a nonionic surfactant,

wherein the sum of a), b) and c) adds up to 100 weight % based on the total weight of the tank mix and wherein the weight % ratio of anionic surfactants to nonionic surfactant is b)≥c).

In another embodiment, the tank-mix consists of
a) 70 to 92 weight % of 1,2-cyclohexandicarboxylic acid diisononyl ester,
b1) 3 to 14.3 weight % of alkylbenzenesulfonates,
b2) 0.2 to 3.75 weight % of sulfosuccinates, and
c) 4 to 15 weight % of a nonionic surfactant,

wherein the sum of a), b) and c) adds up to 100 weight % and wherein the weight % ratio of anionic surfactants to nonionic surfactant is b1)+b2)≥c).

In one embodiment of the invention b1) alkylbenzenesulfonates are selected from the group consisting of alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes. In a further embodiment, b1) alkylbenzenesulfonates are selected from alkylarylsulfonates. In another embodiment, b1) alkylbenzenesulfonates are selected C8-C12 alkylbenzolsulfonate.

In one embodiment of the invention b2) sulfosuccinates are selected from the group consisting of mono- or dicarboxylic acid sulfonates or salts thereof. In another embodiment of the invention, the mono- or dicarboxylic acid sulfonates are linear or branched. In another embodiment of the invention, the mono- or dicarboxylic acid sulfonates are diethylhexylsulfonatsuccinate, isodecylsulfonatsuccinate, octadecanoic acid 9(or 10)-sulfonatsuccinate or salts thereof. In a further embodiment of the invention, the mono-or dicarboxylic acid sulfonates are diethylhexylsulfonatsuccinate Na⁺ salt, isodecylsulfonatsuccinate Na⁺ salt, octadecanoic acid 9(or 10)-sulfonatsuccinate K⁺ salt.

In one embodiment of the invention c) a nonionic surfactant is selected from alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation. In another embodiment of the invention, ethylene oxide may be employed for the alkoxylation. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate. In a further embodiment of the present invention, nonionic surfactants are alkoxylates. Nonionic surfactants such as alkoxylates may also be employed as adjuvants.

In another embodiment of the invention, the tank mix contains at least one alkoxylate as nonionic surfactant, or fatty acids or fatty acid esters which have been alkoxylated with 1 to 50 ethylene oxide and/or propylene oxide units. Ethylene oxide and/or propylene oxide may be employed for the alkoxylation. In another embodiment of the invention, ethylene oxide is employed for the alkoxylation. In another embodiment of the invention, the tank-mix comprises at least one alkoxylated (ethoxylated) triglycerides. In a further embodiment of the invention the alkoxylated fatty acid ester is ethoxylated casteroil with 20 to 45 ethylene oxide units.

In one embodiment, the tank-mix consists of
a) 1,2-cyclohexandicarboxylic acid diisononyl ester,
b) a mixture of anionic surfactants selected from b1) alkylbenzenesulfonates selected from the group consisting of alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, preferably alkylarylsulfonates, more preferably alkylbenzenesulfonates are selected C8-C12 alkylbenzolsulfonate and b2) sulfosuccinates selected from the group consisting of mono- or dicarboxylic acid sulfonates or salts thereof, preferably the mono- or dicarboxylic acid sulfonates are linear or branched, more preferably the mono- or dicarboxylic acid sulfonates are diethylhexylsulfonatsuccinate, isodecylsulfonatsuccinate, octadecanoic acid 9(or 10)-sulfonatsuccinate or salts thereof, even more preferably the mono-or dicarboxylic acid sulfonates are diethylhexylsulfonatsuccinate Na⁺ salt, isodecylsulfonatsuccinate Na⁺ salt, octadecanoic acid 9(or 10)-sulfonatsuccinate K⁺ salt, and
c) a nonionic surfactant selected from alkoxylates, N-substituted fatty acid amides, amine oxides, esters, sugar-based surfactants, polymeric surfactants, and mixtures thereof,

wherein the weight % ratio of b1) to b2) is 3:1 to 20:1 and wherein the weight % ratio of anionic surfactants to nonionic surfactant is b1)+b2)≥c).

In another embodiment, the tank-mix consists of
a) 1,2-cyclohexandicarboxylic acid diisononyl ester,
b) a mixture of anionic surfactants selected from b1) alkylbenzenesulfonates selected from the group consisting of alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, preferably alkylarylsulfonates, more preferably alkylbenzenesulfonates are selected C8-C12 alkylbenzolsulfonate and b2) sulfosuccinates selected from the group consisting of mono- or dicarboxylic acid sulfonates or salts thereof, preferably the mono- or dicarboxylic acid sulfonates are linear or branched, more preferably the mono- or dicarboxylic acid sulfonates are diethylhexylsulfonatsuccinate, isodecylsulfonatsuccinate, octadecanoic acid 9(or 10)-sulfonatsuccinate or salts thereof, even more preferably the mono-or dicarboxylic acid sulfonates are diethylhexylsulfonatsuccinate Na⁺ salt, isodecylsulfonatsuccinate Na⁺ salt, octadecanoic acid 9(or 10)-sulfonatsuccinate K⁺ salt, and
c) a nonionic surfactant selected from alkoxylates, N-substituted fatty acid amides, amine oxides, esters, sugar-based surfactants, polymeric surfactants, and mixtures thereof,

wherein the weight % ratio of b1) to b2) is 3:1 to 20:1, wherein the weight % ratio of anionic surfactants to nonionic surfactant is b1)+b2)≥c) and wherein the weight % ratio of 1,2-cyclohexandicarboxylic acid diisononyl ester to anionic surfactants and nonionic surfactant is a)≥[b1)+b2)+c)].

In another embodiment, the tank-mix consists of
a) 70 to 92 weight % of 1,2-cyclohexandicarboxylic acid diisononyl ester,
b) 4 to 15 weight % of a mixture of anionic surfactants selected from b1) alkylbenzenesulfonates selected from the group consisting of alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, preferably alkylarylsulfonates, more preferably alkylbenzenesulfonates are selected C8-C12 alkylbenzolsulfonate and b2) sulfosuccinates selected from the group consisting of mono- or dicarboxylic acid sulfonates or salts thereof, preferably the mono- or dicarboxylic acid sulfonates are linear or branched, more preferably the mono- or dicarboxylic acid sulfonates are diethylhexylsulfonatsuccinate, isodecylsulfonatsuccinate, octadecanoic acid 9(or 10)-sulfonatsuccinate or salts thereof, even more preferably the mono-or dicarboxylic acid sulfonates are diethylhexylsulfonatsuccinate Na⁺ salt, isodecylsulfonatsuccinate Na⁺ salt, octadecanoic acid 9(or 10)-sulfonatsuccinate K⁺ salt, wherein b1) is present in an amount of 75 to 95 weight % and b2) is present in an amount of 5 to 25 weight % based on the total weight of anionic surfactants, and
c) 4 to 15 weight % of a nonionic surfactant selected from alkoxylates, N-substituted fatty acid amides, amine oxides, esters, sugar-based surfactants, polymeric surfactants, and mixtures thereof,

wherein the sum of a), b) and c) adds up to 100 weight % based on the total weight of the tank mix and wherein the weight % ratio of anionic surfactants to nonionic surfactant is b)≥c).

In another embodiment, the tank-mix consists of
a) 70 to 92 weight % of 1,2-cyclohexandicarboxylic acid diisononyl ester,
b1) 3 to 14.3 weight % of alkylbenzenesulfonates selected from the group consisting of alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, preferably alkylarylsulfonates, more preferably alkylbenzenesulfonates are selected C8-C12 alkylbenzolsulfonate,
b2) 0.2 to 3.75 weight % of sulfosuccinates selected from the group consisting of mono- or dicarboxylic acid sulfonates or salts thereof, preferably the mono- or dicarboxylic acid sulfonates are linear or branched, more preferably the mono- or dicarboxylic acid sulfonates are diethylhexylsulfonatsuccinate, isodecylsulfonatsuccinate, octadecanoic acid 9(or 10)-sulfonatsuccinate or salts thereof, even more preferably the mono-or dicarboxylic acid sulfonates are diethylhexylsulfonatsuccinate Na⁺ salt, isodecylsulfonatsuccinate Na⁺ salt, octadecanoic acid 9(or 10)-sulfonatsuccinate K⁺ salt, and
c) 4 to 15 weight % of a nonionic surfactant selected from alkoxylates, N-substituted fatty acid amides, amine oxides, esters, sugar-based surfactants, polymeric surfactants, and mixtures thereof,

wherein the sum of a), b) and c) adds up to 100 weight % and wherein the weight % ratio of anionic surfactants to nonionic surfactant is b1)+b2)≥c).

The present invention further relates to a spray mix comprising a pesticide and the tank-mix as disclosed above.

The term pesticide refers to at least one active substance selected from the group of the fungicides, insecticides, nematicides, herbicides, safeners, molluscicides, rodenticides and/or growth regulators. In another embodiment of the invention pesticides are fungicides, insecticides, herbicides and growth regulators. In another embodiment of the invention pesticides are herbicides, fungicides and insecticides. Mixtures of pesticides from two or more of the abovementioned classes may also be used. The skilled person is familiar with such pesticides, which can be found, for example, in Pesticide Manual, 14th Ed. (2006), The British Crop Protection Council, London. Suitable pesticides that can be combined with components of the present invention are:

A) strobilurins:
azoxystrobin, dimoxystrobin, coumoxystrobin, coumethoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, methyl 2-[2-(2,5-dimethylphenyloxymethyl)phenyl]-3-methoxyacrylate, 2-(2-(3-(2,6-dichlorophenyl)-1-methylallylideneaminooxymethyl)phenyl)-2-methoxyimino-N-methylacetamide;

B) carboxamides:
carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penflufen (N-(2-(1,3-dimethyl-butyl)phenyl)-1,3-dimethyl-5-fluoro-1H-pyrazole-4-carboxamide), penthiopyrad, sedaxane, tecloftalam, thifluzamide, tiadinil, 2-amino-4-methylthiazole-5-carboxanilide, N-(3′,4′,5′-tri-fluorobiphenyl-2-yl)-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide, N-(2-(1,3,3-trimethylbutyl)phenyl)-1,3-dimethyl-5-fluoro-1H-pyrazole-4-carboxamide;
carboxylic acid morpholides: dimethomorph, flumorph, pyrimorph;
benzamides: flumetover, fluopicolide, fluopyram, zoxamid;
other carboxamides: carpropamid, diclocymet, mandipropamid, oxytetracyclin, silthiofam, N-(6-methoxypyridin-3-yl)cyclopropanecarboxamide;

C) azoles:
triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;
imidazoles: cyazofamid, imazalil, imazalil sulfate, pefurazoate, prochloraz, triflumizole;
benzimidazoles: benomyl, carbendazim, fuberidazole, thiabendazole;
others: ethaboxam, etridiazole, hymexazole, 2-(4-chlorophenyl)-N-[4-(3,4-dimethoxyphenyl)isoxazol-5-yl]-2-prop-2-ynyloxyacetamide;

D) nitrogenous heterocyclyl compounds
pyridines: fluazinam, pyrifenox, 3-[5-(4-chlorophenyl)-2,3-dimethylisoxazolidin-3-yl]pyridine, 3-[5-(4-methylphenyl)-2,3-dimethylisoxazolidin-3-yl]pyridine;
pyrimidines: bupirimate, cyprodinil, diflumetorim, fenarimol, ferimzone, mepanipyrim, nitrapyrin, nuarimol, pyrimethanil;
piperazines: triforine;
pyrroles: fludioxonil, fenpiclonil;
morpholines: aldimorph, dodemorph, dodemorph acetate, fenpropimorph, tridemorph;
piperidines: fenpropidin;
dicarboximides: fluorimid, iprodione, procymidone, vinclozolin;
nonaromatic 5-membered heterocyclic rings: famoxadon, fenamidon, flutianil, octhilinone, probenazole, S-allyl 5-amino-2-isopropyl-3-oxo-4-orthotolyl-2,3-dihydropyrazole-1-thio-carboxylate;
others: acibenzolar-S-methyl, amisulbrom, anilazin, blasticidin-S, captafol, captan, quinomethionate, dazomet, debacarb, diclomezine, difenzoquat, difenzoquat methyl-sulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxypyrimidin-2-yl)-2-methyl-1H-benzimidazole, 5-chloro-7-(4-methylpiperidin-1-yl)-6-(2,4,6-trifluorophenyl)-[1,2,4]triazolo[1,5-a]pyrimidine, 5-ethyl-6-octyl-[1,2,4]triazolo[1,5-a]pyrimidin-7-ylamine;

E) carbamates and dithiocarbamates
thio- and dithiocarbamates: ferbam, mancozeb, maneb, metam, methasulphocarb, metiram, propineb, thiram, zineb, ziram;
carbamates: diethofencarb, benthiavalicarb, iprovalicarb, propamocarb, propamocarb hydrochloride, valiphenal, (4-fluorophenyl) N-(1-(1-(4-cyanophenyl)ethanesulfonyl)-but-2-yl)carbamate;

F) other fungicides
guanidines: dodine, dodine free base, guazatine, guazatine acetate, iminoctadine, iminoctadine triacetate, iminoctadine tris(albesilate);
antibiotics: kasugamycin, kasugamycin hydrochloride hydrate, polyoxins, streptomycin, validamycin A;
nitrophenyl derivatives: binapacryl, dicloran, dinobuton, dinocap, nitrothal-isopropyl, tecnazene;
organometallic compounds: fentin salts such as, for example, fentin acetate, fentin chloride, fentin hydroxide;
sulfurous heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorthalonil, dichlofluanid, dichlorphen, flusulfamide, hexachlorobenzene, pencycuron, pentachlorophenol and its salts, phthalide, quintozene, thiophanate-methyl, tolylfluanid, N-(4-chloro-2-nitrophenyl)-N-ethyl-4-methylbenzenesulfonamide;
inorganic active substances: phosphorous acid and its salts, Bordeaux mixture, copper salts such as, for example, copper acetate, copper hydroxide, copper oxychloride, basic copper sulfate, sulfur;
biological products for controlling fungi, plant strengthening products: Bacillus subtilis strain NRRL No. B-21661 (for example the products RHAPSODY®, SERENADE® MAX and SERENADE® ASO from AgraQuest, Inc., USA.), Bacillus pumilus strain NRRL No. B-30087 (for example SONATA® and BALLAD® Plus from AgraQuest, Inc., USA), Ulocladium oudemansii (for example BOTRY-ZEN from BotriZen Ltd., New Zealand), chitosan (for example ARMOUR-ZEN from BotriZen Ltd., New Zealand).
others: biphenyl, bronopol, cyflufenamid, cymoxanil, diphenylamine, metrafenon, mildiomycin, oxine-copper, prohexadione-calcium, spiroxamin, tolylfluanid, N-(cyclopropyl-methoxyimino-(6-difluoromethoxy-2,3-difluorophenyl)methyl)-2-phenylacetamide, N′-(4-(4-chloro-3-trifluoromethylphenoxy)-2,5-dimethylphenyl)-N-ethyl-N-methylformamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanylpropoxy)phenyl)-N-ethyl-N-methylformamidine, N′-(5-difluoromethyl-2-methyl-4-(3-trimethylsilanylpropoxy)phenyl)-N-ethyl-N-methylformamidine, N-methyl-(1,2,3,4-tetrahydronaphthalen-1-yl)-2-{1-[2-(5-methyl-3-trifluoromethylpyrazol-1-Aacetyl]piperidin-4-yl}thiazole-4-carboxylate, N-methyl-(R)-1,2,3,4-tetrahydronaphthalen-1-yl 2-{1-[2-(5-methyl-3-trifluoromethylpyrazol-1-yl)acetyl]piperidin-4-yl}thiazole-4-carboxylate, 6-tert-butyl-8-fluoro-2,3-dimethylquinolin-4-yl acetate, 6-tert-butyl-8-fluoro-2,3-dimethylquinolin-4-yl methoxyacetate, N-methyl-2-{1-[2-(5-methyl-3-trifluoromethyl-1H-pyrazol-1-yl)acetyl]piperidin-4-yl}-N-[(1R)-1,2,3,4-tetrahydronaphthalen-1-yl]-4-thiazolecarboxamide;

G) growth regulators
abscisic acid, amidochlor, ancymidole, 6-benzylaminopurine, brassinolide, butralin, chlormequat (chlormequat chloride), choline chloride, cyclanilid, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidid, mepiquat (mepiquat chloride), metconazole, naphthaleneacetic acid, N-6-benzyladenine, paclobutrazole, prohexadione (prohexadione-calcium), prohydrojasmone, thidiazuron, triapenthenol, tributylphosphorotrithioate, 2,3,5-triiodobenzoic acid, trinexapacethyl and uniconazole;

H) herbicides
acetamide: acetochlor, alachlor, butachlor, dimethachlor, dimethenamid, flufenacet, mefenacet, metolachlor, metazachlor, napropamid, naproanilid, pethoxamid, pretilachlor, propachlor, thenylchlor;
amino acid analogs: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
bipyridyls: diquat, paraquat;
carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin; diphenyl ethers: acifluorfen, aclonifen, bifenox, diclofop, ethoxyfen, fomesafen, lactofen, oxyfluorfen;
hydroxybenzonitriles: bromoxynil, dichlobenil, ioxynil;
imidazolinones: imazamethabenz, imazamox, imazapic, imazapyr, imazaquin, imazethapyr;
phenoxyacetic acids: clomeprop, 2,4-dichlorophenoxyacetic acid (2,4-D), 2,4-DB, dichlorprop, MCPA, MCPA-thioethyl, MCPB, mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propylimidazo[1,2-b]pyridazin-3-yl)sulfonyl)-3-(4,6-dimethoxypyrimidin-2-yl)urea;
triazines: ametryne, atrazine, cyanazine, dimethametryne, ethiozine, hexazinone, metamitron, metribuzine, prometryne, simazine, terbuthylazine, terbutryne, triaziflam;
ureas: chlortoluron, daimuron, diuron, fluometuron, isoproturon, linuron, methabenz-thiazuron, tebuthiuron;
other acetolactate synthase inhibitors: bispyribac-sodium, cloransulam-methyl, diclosulam, florasulam, flucarbazone, flumetsulam, metosulam, orthosulfamuron, penoxsulam, propoxycarbazone, pyribambenz-propyl, pyribenzoxim, pyriftalide, pyriminobac-methyl, pyrimisulfan, pyrithiobac, pyroxasulfon, pyroxsulam;
others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethlyl, chlorthal, cinmethylin, clomazone, cumyluron, cyprosulfamid, dicamba, difenzoquat, diflufenzopyr, Drechslera monoceras, endothal, ethofumesate, etobenzanid, fentrazamide, flumiclorac-pentyl, flumioxazin, flupoxam, fluorochloridon, flurtamon, indanofan, isoxaben, isoxaflutol, lenacil, propanil, propyzamide, quinclorac, quinmerac, mesotrione, methylarsenic acid, naptalam, oxadiargyl, oxadiazone, oxaziclomefon, pentoxazone, pinoxaden, pyraclonil, pyraflufen-ethyl, pyrasulfotol, pyrazoxyfen, pyrazolynate, quinoclamin, saflufenacil, sulcotrione, sulfentrazone, terbacil, tefuryltrione, tembotrione, thiencarbazone, topramezone, 4-hydroxy-3-[2-(2-methoxyethoxymethyl)-6-trifluoromethylpyridin-3-carbonyl]bicyclo[3.2.1]oct-3-en-2-one, ethyl (3-[2-chloro-4-fluoro-5-(3-methyl-2,6-dioxo-4-trifluoromethyl-3,6-dihydro-2H-pyrimidin-1-yl)phenoxy]pyridin-2-yloxy)acetate, methyl 6-amino-5-chloro-2-cyclo-propylpyrimidine-4-carboxylate, 6-chloro-3-(2-cyclopropyl-6-methylphenoxy)pyridazin-4-ol, 4-amino-3-chloro-6-(4-chlorophenyl)-5-fluoropyridin-2-carboxylic acid, methyl 4-amino-3-chloro-6-(4-chloro-2-fluoro-3-methoxyphenyl)pyridin-2-carboxylate and methyl 4-amino-3-chloro-6-(4-chloro-3-dimethylamino-2-fluorophenyl)pyridin-2-carboxylate;

I) insecticides
organo(thio)phosphates: acephate, azamethiphos, azinphos-methyl, chlorpyrifos, chlorpyrifos-methyl, chlorfenvinphos, diazinon, dichlorvos, dicrotophos, dimethoat, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin,
insect growth inhibitors: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazin; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate;
nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl-[1,3,5]triazinane;
GABA antagonists: endosulfan, ethiprole, fipronil, vaniliprole, pyrafluprole, pyriprole, N-5-amino-1-(2,6-dichloro-4-methylphenyl)-4-sulfinamoyl-1H-pyrazole-3-thiocarboxamide;
macrocyclic lactones: abamectin, emamectin, milbemectin, lepimectin, spinosad, spinetoram;
mitochondrial electron transport chain inhibitor (METI) I acaricides: fenazaquin, pyridaben, tebufenpyrad, tolfenpyrad, flufenerim;
METI II and III substances: acequinocyl, fluacyprim, hydramethylnone;
decouplers: chlorfenapyr;
inhibitors of oxidative phosphorylation: cyhexatin, diafenthiuron, fenbutatin oxide, propargite;
insect ecdysis inhibitors: cryomazin;
‘mixed function oxidase’ inhibitors: piperonyl butoxide;
sodium channel blockers: indoxacarb, metaflumizon;
others: benclothiaz, bifenazate, cartap, flonicamid, pyridalyl, pymetrozin, sulfur, thiocyclam, flubendiamid, chlorantraniliprole, cyazypyr (HGW86); cyenopyrafen, flupyrazofos, cyflumetofen, amidoflumet, imicyafos, bistrifluron and pyrifluquinazone.

In one embodiment, in the spray mix comprising the tank-mix as disclosed above, the pesticide comprises at least one water-insoluble pesticide; preferably, the water-insoluble pesticides have a solubility in water of up to 10 g/l, or up to 1 g/l, or up to 0.5 g/l, at 20° C.

In another embodiment, in the spray mix comprising the tank-mix as disclosed above, the pesticide is soluble in an amount of at least 5 g/l, or at least 20 g/l or at least 40 g/l, at 20° C.

In another embodiment, in the spray mix comprising the tank-mix as disclosed above, the pesticide has a melting point of at least 40° C., or at least 60° C., or at least 80° C.

In another embodiment of the invention, in the spray mix comprising the tank-mix as disclosed above, the pesticide is selected from a fungicide, a herbicide, an insecticide or a mixture thereof. A fungicide or a herbicide or an insecticide in this context shall mean at least one fungicide or at least one herbicide or at least one insecticide. In a further embodiment of the invention, in the spray mix comprising the tank-mix as disclosed above, the fungicide can be selected from triazole fungicides. In another embodiment of the invention, the herbicide can be selected from a hydroxybenzonitrile herbicide. This embodiment of the invention shall also include mixtures of triazole fungicides and hydroxybenzonitriles herbicides, preferably bromoxynil.

The spray mix of the present invention can comprise one or more further pesticides. The term pesticides refers to at least one active substance selected from the group of fungicides, insecticides, nematicides, herbicides, safeners and/or growth regulators. In an embodiment of the present invention pesticides are fungicides other than triazole fungicides, insecticides, herbicides other than hydroxybenzonitrile herbicides and growth regulators.

In another embodiment of the present invention, the further pesticide is water-insoluble. Usually, it is soluble in water to not more than 1 g/l, or not more than 200 mg/l and or not more than 50 mg/l at 25° C. Using simple preliminary experiments, the skilled worker can select a pesticide with a suitable water-solubility. In another embodiment of the present invention, the tank mix does not comprise any further pesticide.

To the spray mix further components can be added such as auxiliaries conventionally used for crop protection products. Suitable auxiliaries are solvents, liquid carriers, dispersants, wetters, adjuvants, solubilizers, penetrants, protective colloids, stickers, thickeners, bactericides, anti-freeze agents, antifoam agents, colorants, adhesives and binders.

Suitable solvents and liquid carriers are organic solvents such as mineral oil fractions with medium to high boiling point, for example kerosene, diesel oil; oils of vegetable or animal origin; aliphatic or cyclic hydrocarbons; alcohols, for example ethanol, propanol, butanol, cyclohexanol; glycols; ketones, for example cyclohexanone; esters, for example carbonates, fatty acid esters, gamma-butyrolactone; fatty acids; phosphonates; amines; amides, for example N-methylpyrrolidone; and their mixtures.

Suitable adjuvants are compounds which have negligible or even no pesticidal activity themselves, and which improve the biological performance of the compound I on the target. Examples are surfactants, mineral or vegetable oils, and other auxilaries. Further examples are listed by Knowles, Adjuvants and Additives, Agrow Reports DS256, T&F lnforma UK, 2006, chapter 5.

Suitable bactericides are bronopol and isothiazolinone derivatives such as alkylisothiazolinones and benzisothiazolinones. Suitable antifreeze agents are ethylene glycol, propylene glycol, urea and glycerol. Suitable antifoam agents are silicones, long-chain alcohols, and salts of fatty acids. Suitable colorants (e.g. in red, blue, or green) are pigments which are sparingly soluble in water, and water-soluble dyes. Examples are inorganic colorants (e.g. iron oxide, titanium oxide, iron hexacyanoferrate) and organic colorants (e.g. alizarin, azo and phthalocyanine colorants). Suitable tackifiers or binders are polyvinylpyrrolidons, polyvinylacetates, polyvinyl alcohols, polyacrylates, biological or synthetic waxes, and cellulose ethers.

The spray mix typically comprises 0.0001 to 10, preferably 0.001 to 5, and more preferably 0.002 to 2.0 weight % of pesticide based on the total amount of the spray mix. Normally 0.2 to 5.0, preferably 0.3 to 3.0 and more preferably 0.35 to 2.0 I of the tank mix of the invention can be diluted with water to 10 to 2000 l, preferably 50 to 1500 l and more preferably 100 to 1000 l.

Typical tank mix concentrations in a spray mix may range from 0.01 to 10, preferably 0.1 to 5, weight % of the spray mix based on the total amount of the spray mix.

The invention furthermore relates to a process for the preparation of the spray mix as disclosed above by mixing the pesticide, the 1,2-cyclohexandicarboxylic acid diisononyl ester, the mixture of anionic surfactants and the nonionic surfactant.

The invention furthermore relates to a controlling phytopathogenic fungi and/or undesirable plant growth and/or undesirable insect or mite infestation and/or for regulating the growth of plants, wherein the spray mix according to the present invention as defined above is allowed to act on the respective pests, the habit thereof or the plants to be protected from the respective pest, on the soil and/or on undesirable plants and/or the crop plants and/or the habitat thereof. The therapeutic treatment of humans and animals is excluded from the method for controlling phytopathogenic fungi.

Examples of suitable crop plants are cereals, for example wheat, rye, barley, triticale, oats or rice; beet, for example sugar or fodder beet; pome fruit, stone fruit and soft fruit, for example apples, pears, plums, peaches, almonds, cherries, strawberries, raspberries, currants or gooseberries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; tobacco; nuts; coffee; tea; bananas; wine (dessert grapes and grapes for vinification); hops; grass, for example turf; sweetleaf (Stevia rebaudania); rubber plants and forest plants, for example flowers, shrubs, deciduous trees and coniferous trees, and propagation material, for example seeds, and harvested products of these plants.

The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant' s properties. Such recombinant modifications also comprise posttranslational modifications of proteins, oligo- or polypeptides, for example by means of glycosylation or binding of polymers such as, for example, prenylated, acetylated or farnesylated residues or PEG residues.

Examples which may be mentioned are plants which, as the result of plant-breeding and recombinant measures, have acquired a tolerance for certain classes of herbicides, such as hydroxyphenylpyruvate dioxygenase (HPPD) inhibitors, acetolactate synthase (ALS) inhibitors such as, for example, sulfonylureas (EP-A 257 993, U.S. Pat. No. 5,013,659) or imidazolinones (for example U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073), enolpyruvylshikimate 3-phosphate synthase (EPSPS) inhibitors such as, for example, glyphosate (see, for example, WO 92/00377), glutamine synthetase (GS) inhibitors such as, for example, glufosinate (see, for example, EP-A 242 236, EP-A 242 246) or oxynil herbicides (see, for example, U.S. Pat. No. 5,559,024). For example, breeding and mutagenesis have given rise to Clearfield® oilseed rape (BASF SE, Germany), which features tolerance for imidazolinones, for example imazamox. With the aid of recombinant methods, crop plants such as soybeans, cotton, maize, beet and oilseed rape have been generated which are resistant to glyphosate or glufosinate, and these are available by the brand names RoundupReady® (glyphosate-resistant, Monsanto, U.S.A.) and Liberty Link® (glufosinate-resistant, Bayer CropScience, Germany).

Also comprised are plants which, with the aid of recombinant measures, produce one or more toxins, for example those from the bacterial strain Bacillus. Toxins which are produced by such genetically modified plants comprise, for example, insecticidal proteins of Bacillus spp., in particular from B. thuringiensis; such as the endotoxins Cry1Ab, Cry1Ac, Cry1F, Cry1Fa2, Cry2Ab, Cry3A, Cry3Bb1, Cry9c, Cry34Ab1 or Cry35Ab1; or vegetable insecticidal proteins (VIPs), for example VIP1, VIP2, VIP3, or VIP3A; insecticidal proteins from nematode-colonizing bacteria, for example Photorhabdus spp. or Xenorhabdus spp.; toxins from animal organisms, for example wasp, spider or scorpion toxins; fungal toxins, for example from Streptomycetes; plant lectins, for example from pea or barley; agglutinins; proteinase inhibitors, for example trypsin inhibitors, serine protease inhibitors, patatin, cystatin or papain inhibitors; ribosome-inactivating proteins (RIPs), for example ricin, maize RIP, abrin, luffin, saporin or bryodin; steroid-metabolizing enzymes, for example 3-hydroxysteroid oxidase, ecdysteroid IDP glycosyl transferase, cholesterol oxidase, ecdysone inhibitors or HMG CoA-reductase; ion channel blockers, for example inhibitors of sodium or calcium channels; juvenile hormone esterase; receptors for the diuretic hormone (helicokinin receptors); stilbene synthase, bibenzyl synthase, chitinases and glucanases. These toxins can also be produced, in the plants, in the form of pretoxins, hybrid proteins, truncated or otherwise modified proteins. Hybrid proteins are distinguished by a novel combination of different protein domains (see, for example, WO 2002/015701). Further examples of such toxins or genetically modified plants which produce these toxins are disclosed in EP-A 374 753, WO 93/07278, WO 95/34656, EP-A 427 529, EP-A 451 878, WO 03/18810 and WO 03/52073. The methods for generating these genetically modified plants are known to the skilled person and explained, for example, in the abovementioned publications. A large number of the abovementioned toxins impart to the plants which produce them a tolerance for pests from all taxonomic classes of the arthropods, in particular beetles (Coeleropta), dipterans (Diptera) and lepidopterans (Lepidoptera) and nematodes (Nematoda). Genetically modified plants having one or more genes which code for insecticidal toxins are described for example in the abovementioned publications and are in some cases commercially available such as, for example, YieldGard® (maize varieties which produce the toxin Cry1Ab), YieldGard® Plus (maize varieties which produce the toxins Cry1Ab and Cry3Bb1), Starink® (maize varieties which produce the toxin Cry9c), Herculex® RW (maize varieties which produce the toxins Cry34Ab1, Cry35Ab1 and the enzyme phosphinothricin N-acetyltransferase [PAT]); NuCOTN® 33B (cotton varieties which produce the toxin Cry1Ac), Bollgard® I (cotton varieties which produce the toxin Cry1Ac), Bollgard® II (cotton varieties which produce the toxins Cry1Ac and Cry2Ab2); VIPCOT® (cotton varieties which produce a VIP toxin); NewLeaf® (potato varieties which produce the toxin Cry3A); Bt-Xtra®, NatureGard®, KnockOut®, BiteGard®, Protecta®, Bt11 (for example Agrisure® CB) and Bt176 from Syngenta Seeds SAS, France, (maize varieties which produce the toxin Cry1Ab and the PAT enzyme), MIR604 from Syngenta Seeds SAS, France (maize varieties which produce a modified version of the toxin Cry3A, see in this context WO 03/018810), MON 863 from Monsanto Europe S.A., Belgium (maize varieties which produce the toxin Cry3Bb1), IPC 531 from Monsanto Europe S.A., Belgium (cotton varieties which produce a modified version of the toxin Cry1Ac) and 1507 from Pioneer Overseas Corporation, Belgium (maize varieties which produce the toxin Cry1F and the PAT enzyme).

Also comprised are plants which, with the aid of recombinant measures, produce one or more proteins which bring about an increased resistance to, or ability to withstand, bacterial, viral or fungal pathogens such as, for example, so-called pathogenesis-related proteins (PR proteins, see EP-A 0 392 225), resistance proteins (for example potato varieties which produce two resistance genes against Phytophthora infestans from the Mexican wild potato Solanum bulbocastanum) or T4 lysozyme (for example potato varieties which, as the result of the production of this protein, are resistant to bacteria such as Erwinia amylvora).

Also comprised are plants whose productivity has been improved with the aid of recombinant methods, for example by increasing the yield potential (for example biomass, grain yield, starch content, oil content or protein content), the tolerance for drought, salt or other limiting environmental factors, or the resistance to pests and fungal, bacterial and viral pathogens.

Also comprised are plants whose constituents, in particular for improving human or animal nutrition, have been modified with the aid of recombinant methods, for example by oil plants producing health-promoting long-chain omega-3-fatty acids or monounsaturated omega-9-fatty acids (for example Nexera® oilseed rape, DOW Agro Sciences, Canada).

When employed in crop protection, the application rates of the pesticides amount to from 0.001 to 2 kg per ha, from 0.005 to 2 kg per ha, from 0.05 to 0.9 kg per ha or from 0.1 to 0.75 kg per ha, depending on the nature of the desired effect. In treatment of plant propagation materials such as seeds, e.g. by dusting, coating or drenching seed, amounts of active substance of from 0.1 to 1000 g, or from 1 to 1000 g, or from 1 to 100 g or from 5 to 100 g, per 100 kg of plant propagation material (preferably seed) are generally required. When used in the protection of materials or stored products, the amount of active substance applied depends on the kind of application area and on the desired effect. Amounts customarily applied in the protection of materials are 0.001 g to 2 kg, or 0.005 g to 1 kg, of active substance per cubic meter of treated material.

Various types of oils, wetters, adjuvants, fertilizers or micronutrients and further pesticides (for example herbicides, insecticides, fungicides, growth regulators, safeners) may be added to the spray mix of the present invention in the form of a premix or optionally only shortly before use. These agents can be admixed to the formulations according to the invention at a weight ratio of from 1:100 to 100:1, or from 1:10 to 10:1.

The user applies the spray mix according to the invention usually from a predosage device, a knapsack sprayer, a spray tank, a spray plane, or an irrigation system. Usually, the tank-mix is made up with water, buffer, pesticide and/or further auxiliaries to the desired application concentration and the ready-to-use spray liquor or the spray mix according to the invention is thus obtained. Usually, 20 to 2000 liters, or 50 to 400 liters, of the ready-to-use spray liquor are applied per hectare of agricultural useful area.

Advantages of the present invention are, inter alia, that the tank-mix is stable in water and that the spray mix shows increased performance of the active ingredient on the plant.

The examples which follow illustrate the invention without imposing any limitation.

### EXAMPLES

Solvent: 1,2-cyclohexandicarboxylic acid diisononyl ester

Non-ionic surfactant 1 (NS1): liquid ethoxylated castor oil, 40 ethylene oxide units

Non-ionic surfactant 2 (NS2): Oxirane, methyl-, polymer with oxirane, monobutyl ether (EO/PO-blockcopolymer surfactant)

Non-ionic surfactant 3 (NS3): C10 Guerbet alcohol ethoxylate, 10 EO

Non-ionic surfactant 4 (NS4): C13/C15 Oxo alcohol ethoxylate, 3EO

Non-ionic surfactant 5 (NS5): liquid ethoxylated castor oil, 30 ethylene oxide units

Non-ionic surfactant 6 (NS6): liquid ethoxylated castor oil, 20 ethylene oxide units

Anionic surfactant 1 (AS1): Ca-Dodecylbenzene sulfonate

Anionic surfactant 2 (AS2): Diethylhexylsulfonatsuccinate Na⁺ salt

Anionic surfactant 3 (AS3): Isodecylsulfonatsuccinate Na⁺ salt

Anionic surfactant 4 (AS4): Octadecanoic acid 9(or 10)-sulfonatsuccinate K⁺ salt

### Examples 1: Preparation of Tank-Mixes and Stability Test

The tank-mixes were prepared by mixing the components as described in Table 1. The stability has been assessed at room temperature according to CIPAC method MT 36. Examples according to the invention are TM 1 to TM5 in Table 2. CTM 1 to CTM 10 represent comparative tank-mixes in Table 1.

TABLE 1
Composition Comparative Tank-mixes (all data in wt %)

| | CTM | CTM | CTM | CTM | CTM | CTM | CTM | CTM | CTM | CTM |
|---|---|---|---|---|---|---|---|---|---|---|
| | 1 | 2 | 3 | 4 | 5 | 6 | 7 | 8 | 9 | 10 |
| Solvent | 95 | 95 | 95 | 95 | 95 | 95 | 88 | 88 | 88 | 88 |
| NS1 | 1.25 | 2.5 | 1.25 | — | — | — | — | — | — | — |
| NS2 | 2.5 | 1.25 | 1.25 | 2.5 | 1.25 | 1.25 | — | — | — | — |
| NS3 | — | — | — | 0.625 | 1.25 | 0.625 | — | — | — | — |
| NS4 | — | — | — | 0.625 | 1.25 | 0.625 | — | — | — | — |
| NS5 | — | — | — | — | — | — | 4 | 6 | 8 | 8 |
| NS6 | — | — | — | — | — | — | — | — | — | — |
| AS1 | 1.25 | 1.25 | 2.5 | 1.25 | 1.25 | 2.5 | 8 | 6 | 4 | 3.5 |
| AS2 | — | — | — | — | — | — | — | — | — | 0.5 |
| AS3 | — | — | — | — | — | — | — | — | — | — |
| AS4 | — | — | — | — | — | — | — | — | — | — |

TABLE 2
Composition Tank-mixes (all data in wt %)

| | TM 1 | TM 2 | TM 3 | TM 4 | TM 5 |
|---|---|---|---|---|---|
| Solvent | 88 | 88 | 88 | 88 | 88 |
| NS1 | — | — | — | — | — |
| NS2 | — | — | — | — | — |
| NS3 | — | — | — | — | — |
| NS4 | — | — | — | — | — |
| NS5 | — | 4 | 4 | 4 | 4 |
| NS6 | 4 | — | — | — | — |
| AS1 | 7 | 7 | 6.4 | 7.5 | 7.5 |
| AS2 | 1 | 1 | 1.6 | — | — |
| AS3 | — | — | — | 0.5 | — |
| AS4 | — | — | — | — | 0.5 |

Each tank-mix of Table 1 was diluted in CIPAC water D (5% w/w EC in CIPAC water D).

The resulting tank-mixes were assessed according to their emulsion stability over time. The results are shown in Tables 3 and 4.

TABLE 3
Stability test (5% CTM in CIPAC water D)

| | CTM | CTM | CTM | CTM | CTM | CTM | CTM | CTM | CTM | CTM |
|---|---|---|---|---|---|---|---|---|---|---|
| | 1 | 2 | 3 | 4 | 5 | 6 | 7 | 8 | 9 | 10 |
| After 30 | unstable | Very | stable | unstable | Very | unstable | Stable | stable | stable | stable |
| minutes | | unstable | | | unstable | | | | | |
| After | Very | Very | Very | Very | Very | Very | unstable | Unstable | Unstable | Very |
| 24 h | unstable | unstable | unstable | unstable | unstable | unstable | | | | unstable |

TABLE 4
Stability test (5% TM in CIPAC water D)

| | TM 1 | TM 2 | TM 3 | TM 4 | TM 5 |
|---|---|---|---|---|---|
| After 30 | stable | stable | stable | stable | stable |
| minutes | | | | | |
| After 24 h | stable | stable | stable | stable | stable |

Cipac D: water hardness 432 ppm (Ca:Mg = 4:1)
Stable: no cream to maximum 2 ml cream
Unstable: means 2 ml < x ml ≤ 5 ml cream
Very unstable: >5 ml cream

### Example 2: Improved Performance of Formulation

Method: Biofluorescence

Chlorophyll fluorescence is light re-emitted by chlorophyll molecules during return from excited to non-excited states and used as indicator of photosynthetic energy conversion

When light is applied to plants energy is mainly used for photosynthesis. Minor portion of the energy is transferred into heat and fluorescence. Herbicides working as photosystem H inhibitors block the regular photosynthesis activity and more energy is transferred into fluorescence. This fluorescence increase can be captured and used as indirect measurement of herbicide activity.

| Recipe | 1 | 2 | 3 |
|---|---|---|---|
| Bromoxynil-K | 0.25% | 0.25% | 0.25% |
| NS5 (33.4%), | — | 0.12% | — |
| AS1 (58.3%), | | | |
| AS2 (8.3%) | | | |
| TM2 | — | | 1% |
| Water | add to 100 | add to 100 | add to 100 |

Weed: black bindweed

5 μl of each formulation (see Recipe above) are applied on leaves. 5 leaves per recipe and 2 droplets per leaf.

Characteristics captured: increase in fluorescence and fluorescent area

Multiplying fluorescence intensity by fluorescent area lead to a characteristic considered as indicator for the performance of the respective recipe. The higher the figure the better the adjuvant (in this case tank mix) efficacy. The results are shown in Table 5.

TABLE 5
Results

| Recipe | 1 | 2 | 3 |
|---|---|---|---|
| Increase fluorescence | 0.13 | 0.09 | 0.154 |
| Area mm² | 9.46 | 34.2 | 59.93 |
| Fluorescence index | 1.23 | 3.07 | 9.21 |

Adding solvent of the invention as tank mix component, leads to a strongly increased efficacy of the active ingredient.

1. A tank-mix comprising:
a) 1,2-cyclohexandicarboxylic acid diisononyl ester,
b) a mixture of anionic surfactants selected from b1) alkylbenzenesulfonates and b2) sulfosuccinates, and
c) a nonionic surfactant,
wherein a weight % ratio of b1) to b2) is 3:1 to 20:1 and wherein a weight % ratio of anionic surfactants to nonionic surfactant is b1)+b2)≥c).

2. The tank-mix according to claim 1, wherein the weight % ratio of b1) dodecylbenzenesul-fonates to b2) sulfosuccinates is from 3:1 to 20:1 and wherein the weight % ratio of anionic surfactants to nonionic surfactant is b1)+b2)>c).

3. The tank-mix according to claim 1, wherein the weight % ratio of b1) dodecylbenzene-sulfonates to b2) sulfosuccinates is from 3:1 to 10:1 and wherein the weight % ratio of anionic surfactants to nonionic surfactant is b1)+b2)≥c).

4. The tank-mix according to claim 1, wherein b1) is present in an amount of 75 to 95 weight % and b2) is present in an amount of 5 to 25 weight % based on a total amount of anionic surfactants.

5. A tank-mix according to claim 1, comprising:
a) 70 to 92 weight % of 1,2-cyclohexandicarboxylic acid diisononyl ester,
b) 4 to 15 weight % of a mixture of anionic surfactants selected from b1) alkylbenzenesulfonates and b2) sulfosuccinates, wherein b1) is present in an amount of 75 to 95 weight % and b2) is present in an amount of 5 to 25 weight % based on a total weight of anionic surfactants, and
c) 4 to 15 weight % of a nonionic surfactant,
wherein the sum of a), b) and c) adds up to 100 weight % based on a total weight of the tank-mix and wherein the weight % ratio of anionic surfactants to nonionic surfactant is b)≥c).

6. The tank-mix according to claim 1, wherein the nonionic surfactant is an alkoxylate.

7. The tank-mix according to claim 1, wherein the nonionic surfactant is a castor oil alkoxylate.

8. The tank-mix according to claim 1, wherein b) is a mixture of b1) do-decylbenzenesulfonates and b2) sulfosuccinates.

9. A spray mix comprising a pesticide and the tank-mix according to claim 1.

10. A process for the preparation of the spray mix according to claim 9 by mixing the pesticide, the 1,2-cyclohexandicarboxylic acid diisononyl ester, the mixture of anionic surfactants and the nonionic surfactant.

11. A non-therapeutic method for controlling phytopathogenic fungi and/or undesirable plant growth and/or undesirable insect or mite infestation and/or for regulating the growth of plants, wherein the spray mix according to claim 9 is allowed to act on the respective pests, the habit thereof or the plants to be protected from the respective pest, on the soil and/or on undesirable plants and/or the crop plants and/or the habitat thereof.
